(19) United States
(12) Patent Application Publication
(10) Pub. No.: US 2010/0306421 A1
(43) Pub. Date: Dec. 2, 2010

(54) DMA TRANSFER DEVICE

(75) Inventors: Takashi MAEDA, Kanagawa (JP); Daisuke Yamamoto, Osaka (JP)

Correspondence Address: McDERMOTT WILL & EMERY LLP, 600 13th Street, N.W., Washington, DC, 20005-3096, US

(73) Assignee: PANASONIC CORPORATION, Osaka (JP)

(21) Appl. No.: 12/853,092

(22) Filed: Aug. 9, 2010

Related U.S. Application Data
(63) Continuation of application No. PCT/JP2009/000227, filed on Jan. 22, 2009.

(30) Foreign Application Priority Data
Mar. 3, 2008 (JP) 2008-051737

(51) Int. Cl. G06F 13/28

(52) U.S. Cl. 710/22

(57) ABSTRACT

A source address setting detector acquires a DMA source address from a transfer start address setting for a DMA source area of a plurality of register settings for a DMAC which are made by a master. A read-ahead processor reads ahead data in a resource which is specified by the DMA source address before the DMAC starts DMA transfer, and further, increments the DMA source address to repeat read-ahead operation. The DMAC starts DMA transfer if the master completes the register settings, reads data in the DMA source area which has already been read ahead in the read-ahead processor, and transfers the data to a DMA destination area in the resource.

### CROSS-REFERENCE TO RELATED APPLICATION

This is a continuation of PCT International Application PCT/JP2009/000227 filed on Jan. 22, 2009, which claims priority to Japanese Patent Application No. 2008-051737 filed on Mar. 3, 2008. The disclosures of these applications including the specifications, the drawings, and the claims are hereby incorporated by reference in their entirety.

### BACKGROUND

The present invention relates to direct memory access (DMA) transfer devices, and more particularly, to techniques of increasing the rate of DMA transfer by performing read-ahead operation with respect to source data when the DMA transfer is performed by a direct memory access controller (DMAC).

As shown in FIG. 1, a DMA transfer device 101 includes a DMAC 102 and a resource 103. The DMAC 102 performs DMA transfer, i.e., reads data from a DMA source area in the resource 103, and writes the read data to a DMA destination area in the resource 103. A conventional read-ahead technique of increasing the rate of DMA transfer will be described hereinafter with reference to FIG. 2.

A DMA transfer device 201 includes a DMAC 202, a read-ahead processor 203, and a resource 204. The DMAC 202 performs DMA transfer, i.e., reads data from a DMA source area in the resource 204 via the read-ahead processor 203, and writes the read data to a DMA destination area in the resource 204.

The read-ahead processor 203 includes a read-ahead address register 205, a controller 206, a read-ahead data storing buffer 207, an addition circuit 208, and selectors 209 and 210. The read-ahead address register 205 stores a read address of a DMA source area from which the DMAC 202 is to read data. The selector 209 selects one of the read address stored in the read-ahead address register 205 and a read address output from the DMAC 202, and outputs the selected read address to the resource 204. The read-ahead data storing buffer 207 stores data read ahead from the resource 204. The selector 210 selects one of the data stored in the read-ahead data storing buffer 207 and data read directly from the resource 204, and returns the selected data to the DMAC 202. The controller 206 controls the selection operations of the selectors 209 and 210.

The read-ahead processor 203, when receiving a read address from the DMAC 202, compares the received read address with the read address stored in the read-ahead address register 205.

When both the read addresses match, data in the resource 204 which is specified by the read address is already stored in the read-ahead data storing buffer 207. Therefore, in this case, the data stored in the read-ahead data storing buffer 207 is returned to the DMAC 202. Further, the read address stored in the read-ahead address register 205 is incremented by the addition circuit 208, and data in the resource 204 which is specified by the incremented read address is read out and stored into the read-ahead data storing buffer 207.

On the other hand, when both the read addresses do not match, data in the resource 204 which is specified by the read address received from the DMAC 202 is not stored in the read-ahead data storing buffer 207. Therefore, in this case, the read address received from the DMAC 202 is output to the resource 204, and read data is directly returned to the DMAC 202. Further, the read address is incremented by the addition circuit 208 and the incremented read address is stored into the read-ahead address register 205, and data in the resource 204 which is specified by the read-ahead address register 205 is read out and stored into the read-ahead data storing buffer 207. By these operations, read-ahead operation is performed with respect to a DMA source area, resulting in an increase in the rate of DMA transfer (see, for example, Japanese Patent Publication No. H02-110646).

When the DMAC 202 reads data from successive address spaces in a DMA source area by DMA transfer, the conventional read-ahead processor 203 operates as follows. When the DMAC 202 outputs the first read address, the read-ahead processor 203 reads data from the resource 204 instead of the DMAC 202 and returns the data to the DMAC 202, and increments the received read address to acquire a read address from which the DMAC 202 next reads data, and reads ahead data in the resource 204 which is specified by the incremented read address. Thereafter, when the DMAC 202 outputs the next read address, the read-ahead processor 203 returns the read-ahead data to the DMAC 202. As a result, the DMAC 202 is allowed to read DMA source data at a higher rate. However, the conventional read-ahead processor 203 cannot increase the rate of the first one of the read operations from a DMA source area.

Moreover, general DMACs cannot start DMA transfer until a master which controls the DMAC completes register settings (a source address, a destination address, a transfer method, and the like) for the DMAC. Specifically, conventional read-ahead processors are not supposed to reduce the cycle from when the master starts setting with respect to the DMAC to when the first read operation from a DMA source area is completed. This poses a problem with systems in which immediate activation of DMA is required.

### SUMMARY

The present invention has been made in view of the foregoing. It is an object of the present invention to increase the rate of DMA transfer.

To achieve the aforementioned object, in the present invention, a DMA source address is acquired from a transfer start address setting for a DMA source area of a plurality of register settings for a DMAC which are made by a master, and data in a resource which is specified by the DMA source address is read ahead.

Therefore, a DMA transfer device according to the present invention includes a source address setting detector configured to acquire a DMA source address from a plurality of register settings for a DMAC which are made by a master, and a read-ahead processor configured to read ahead data in a resource which is specified by the DMA source address. The read-ahead processor includes a read-ahead address register configured to store the DMA source address, and a read-ahead data storing buffer configured to issue a source address stored in a read-ahead address register to the resource, and store read data.

In the present invention, a DMA source address is acquired from a transfer start address setting for a DMA source area of a plurality of register settings for a DMAC which are made by a master. In response to this, the read-ahead processor reads ahead data specified by the DMA source address without waiting for start of DMA transfer performed by the DMAC. The DMAC starts reading of a DMA source from the data read ahead by the read-ahead processor. As a result, the rate of the first one of the read operations in DMA transfer can be increased.

Moreover, of a plurality of register settings for a DMAC which are made by a master, a transfer start address setting for a DMA source area is set first to start read-ahead operation, whereby the subsequent register setting cycles can be concealed.

Moreover, a cache which is used by the DMAC is provided. Read-ahead data is stored in the cache, and the stored read-ahead data is transferred to a DMA destination in the cache, whereby the rate of write operation in DMA transfer can also be increased.

### BRIEF DESCRIPTION OF THE DRAWINGS

FIG. 1 is a diagram schematically showing a configuration of a general DMA transfer device.

FIG. 2 is a diagram schematically showing a configuration of a conventional DMA transfer device in which the rate of DMA transfer is increased by read-ahead operation.

FIG. 3 is a diagram showing an entire configuration of DMA transfer devices according to first to third embodiments.

FIG. 4 is a diagram showing an internal configuration of a read-ahead processor of the first embodiment.

FIG. 5 is a diagram showing an internal configuration of a read-ahead processor of the second embodiment.

FIG. 6 is a diagram showing an internal configuration of a read-ahead processor of the third embodiment.

FIG. 7 is a diagram showing an entire configuration of a DMA transfer device according to a fourth embodiment.

FIG. 8 is a diagram showing an entire configuration of a DMA transfer device according to a fifth embodiment.

FIG. 9 is a diagram showing internal configurations of a read-ahead processor and a cache of the fifth embodiment.

FIG. 10 is a diagram showing an entire configuration of a DMA transfer device according to a sixth embodiment.

FIG. 11 is a diagram showing internal configurations of a read-ahead processor and a shared cache of the sixth embodiment.

FIG. 12 is a diagram showing an internal configuration of a cache memory shown in FIG. 11.

FIG. 13A is a diagram showing an initial state of a memory unit, and FIG. 13B is a diagram showing a state of the memory unit after refilling.

FIG. 14 is a diagram showing example addresses.

FIG. 15A is a diagram showing an initial state of a memory unit, and FIG. 15B is a diagram showing a state of the memory unit after data in a line (eight words) of a DMA source area which is stored in a cache memory is transferred to a DMA destination area in the cache memory.

FIG. 16 is a diagram showing example addresses.

FIG. 17 is a diagram showing an internal configuration of a cache memory of a seventh embodiment.

FIG. 18A is a diagram showing an initial state of a memory unit, and FIG. 18B is a diagram showing a state of the memory unit after refilling.

FIG. 19 is a diagram showing example addresses.

FIG. 20A is a diagram showing an initial state of the memory unit, and FIG. 20B is a diagram showing a state of the memory unit after data in a line (eight words) of the cache memory is DMA-transferred.

FIG. 21 is a diagram showing example addresses.

FIG. 22 is a diagram showing an internal configuration of a cache memory of an eight embodiment.

FIG. 23 is a diagram showing an entire configuration of a DMA transfer device according to a ninth embodiment.

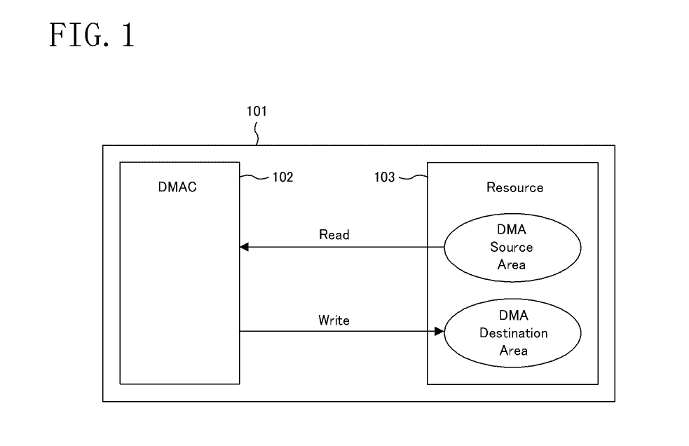

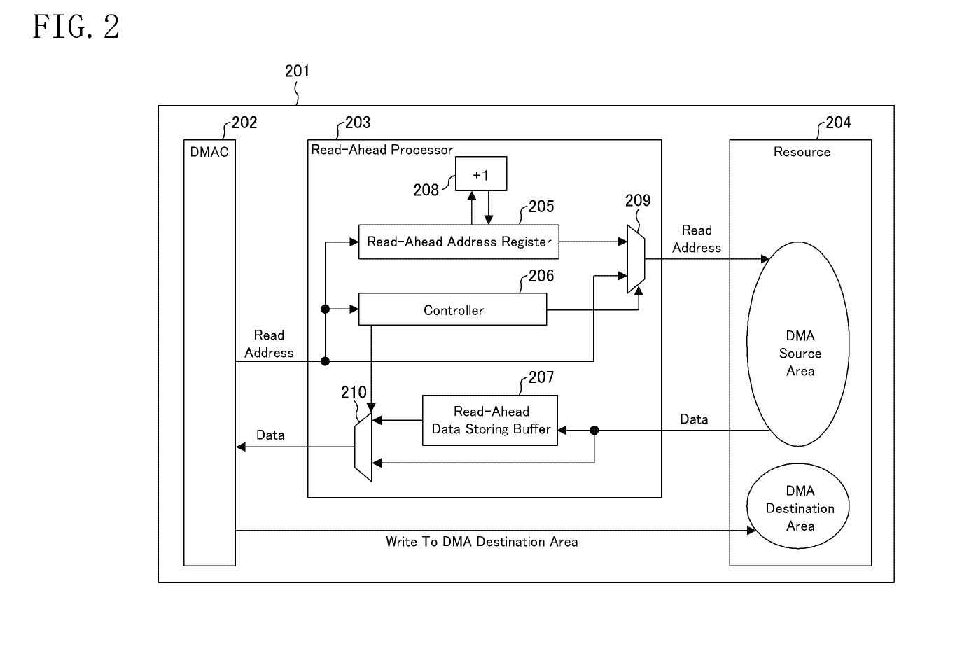

### DETAILED DESCRIPTION

Embodiments of the present invention will be described hereinafter with reference to the accompanying drawings.

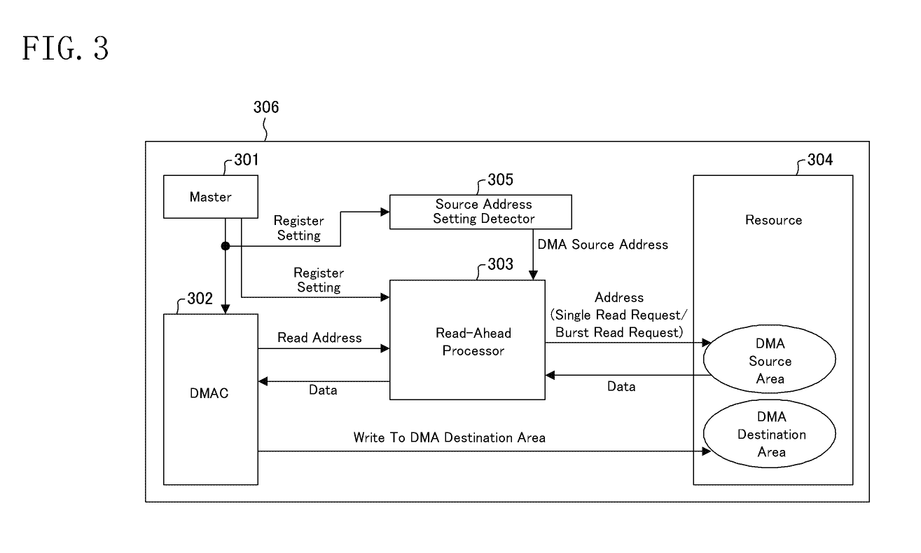

FIG. 3 is a diagram showing an entire configuration of DMA transfer devices according to first to third embodiments of the present invention. The DMA transfer device 306 includes a DMAC 302, a master 301 which controls the DMAC 302, a read-ahead processor 303, and a source address setting detector 305.

The source address setting detector 305 acquires a DMA source address from a transfer start address setting for a DMA source area of a plurality of register settings for the DMAC 302 which are made by the master 301. The read-ahead processor 303 reads ahead data in a resource 304 which is specified by the DMA source address acquired by the source address setting detector 305.

When the master 301 completes the register settings for the DMAC 302, the DMAC 302 starts DMA transfer, i.e., reads data in the DMA source area of the resource 304 which has been read ahead by the read-ahead processor 303, and transfers the data to a DMA destination area in the resource 304.

### First Embodiment

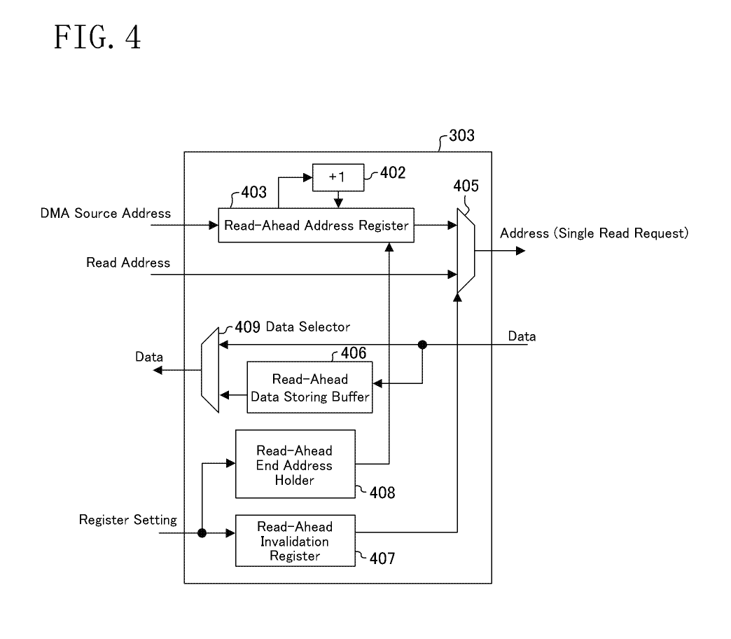

The DMA transfer device of this embodiment has an entire configuration shown in FIG. 3, and the read-ahead processor 303 of this embodiment has a configuration shown in FIG. 4.

As shown in FIG. 4, the read-ahead processor 303 includes an addition circuit 402, a read-ahead address register 403, an address selector 405, a read-ahead data storing buffer 406, a read-ahead invalidation register 407, a read-ahead end address holder 408, and a data selector 409. The read-ahead address register 403 holds an address. The address selector 405 selects one of the address stored in the read-ahead address register 403 and a read address received from the DMAC 302, and outputs the selected data to the resource 304. The read-ahead data storing buffer 406 stores data read from the resource 304. The data selector 409 selects one of the data stored in the read-ahead data storing buffer 406 and data received from the resource 304, and outputs the selected data the DMAC 302.

Next, operation of the DMA transfer device 306 of this embodiment will be described.

When receiving a DMA source address from the source address setting detector 305, the read-ahead processor 303 stores the DMA source address into the read-ahead address register 403. Further, the read-ahead processor 303 controls the address selector 405 to issue a single read request to the address in the resource 304 which is held by the read-ahead address register 403 to read ahead one-word data, and stores the read-ahead one-word data into the read-ahead data storing buffer 406.

When receiving a read address from the DMAC 302, the read-ahead processor 303 selects data which is already stored in the read-ahead data storing buffer 406, i.e., data in the resource 304 which is specified by the read address, using the data selector 409, and returns the data to the DMAC 302, and in addition, increments the address held in the read-ahead address register 403 by one word using the addition circuit 402, and reads ahead data in preparation for the next DMA transfer. By repeating this, read-ahead operation can be performed with respect to the DMA source area in the resource (slave) 304.

The read-ahead invalidation register 407 performs a control so that the address selector 405 directly outputs to the resource (slave) 304 a read address which is received from the DMAC 302, and the data selector 409 selects data read from the resource (slave) 304 and directly returns the data to the master 301. As a result, the read-ahead function can be activated and inactivated.

The read-ahead end address holder 408 holds an end address of the DMA source area. A control may be performed so that, if the address in the read-ahead address register 403 reaches the end address held by the read-ahead end address holder 408, the read-ahead operation is no longer performed. In this case, if the read-ahead operation is completed for the entire DMA source area, the read-ahead operation can be inactivated.

Note that the values held by the read-ahead invalidation register 407 and the read-ahead end address holder 408 can be set and changed according to register settings of the master 301.

### Second Embodiment

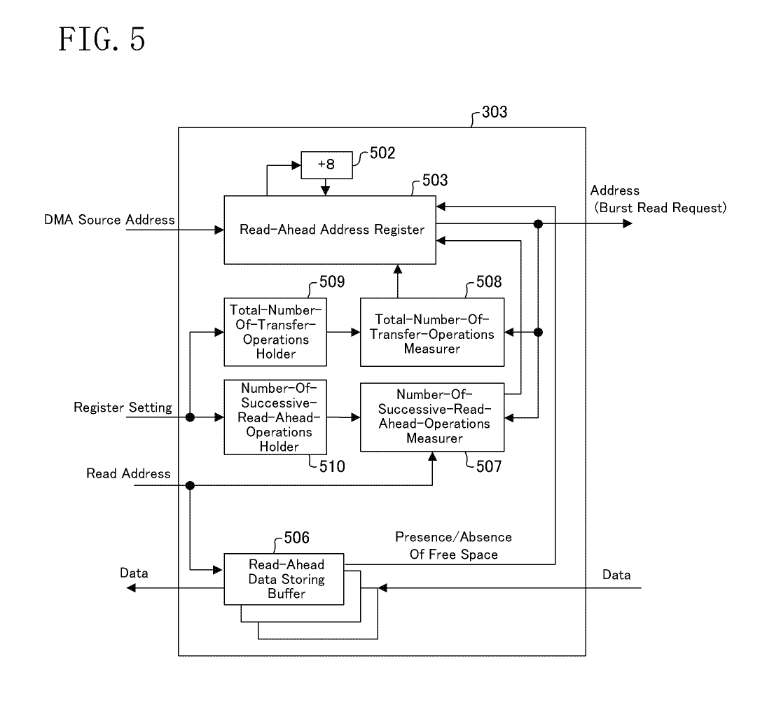

The DMA transfer device of this embodiment has an entire configuration shown in FIG. 3, and the read-ahead processor 303 of this embodiment has a configuration shown in FIG. 5.

As shown in FIG. 5, the read-ahead processor 303 includes an addition circuit 502, a read-ahead address register 503, a read-ahead data storing buffer 506 which can store a plurality of words, a number-of-successive-read-ahead-operations measurer 507, a total-number-of-transfer-operations measurer 508, a total-number-of-transfer-operations holder 509, and a number-of-successive-read-ahead-operations holder 501.

Next, operation of the DMA transfer device 306 of this embodiment will be described.

When receiving a DMA source address from the source address setting detector 305, the read-ahead processor 303 stores the DMA source address into the read-ahead address register 503. Further, the read-ahead processor 303 issues a burst read request (eight-word-successive-read request) to the address in the resource 304 which is held by the read-ahead address register 503 to read ahead eight-word data, and stores the read-ahead eight-word data into the read-ahead data storing buffer 506.

When receiving a read address from the DMAC 302, the read-ahead processor 303 returns to the DMAC 302 data which is already stored in the read-ahead data storing buffer 506, i.e., data in the resource 304 which is specified by the read address. When there is a free space in the read-ahead data storing buffer 506, the read-ahead processor 303 increments the address held by the read-ahead address register 503 by eight words using the addition circuit 502 in preparation for the next DMA transfer, and issues a burst read request to the resultant address to read ahead the next eight words.

By repeating this, data can be read ahead from the DMA source area in resource (slave) 304 by burst transfer.

The number-of-successive-read-ahead-operations measurer 507 increases the count by one when a read request is issued to a read address in the resource 304 which is held by the read-ahead address register 503, and decreases the count by one when the DMAC 302 reads out read-ahead data stored in the read-ahead data storing buffer 506. The number-of-successive-read-ahead-operations holder 510 specifies the upper limit of the count of the number-of-successive-read-ahead-operations measurer 507. When the count value of the number-of-successive-read-ahead-operations measurer 507 exceeds the upper limit set in the number-of-successive-read-ahead-operations holder 510, the issuance of a read address is temporarily stopped, and when the count value of the number-of-successive-read-ahead-operations measurer 507 becomes lower than the upper limit set in the number-of-successive-read-ahead-operations holder 510, the issuance of a read address is resumed. As a result, a control can be performed to prevent read-ahead operation which would otherwise cause overflow of the read-ahead data storing buffer 506.

The total-number-of-transfer-operations measurer 508 counts the number of times that a read request is issued to a read address in the resource 304 which is held by the read-ahead address register 503. The total-number-of-transfer-operations holder 509 specifies the upper limit of the count of the total-number-of-transfer-operations measurer 508. By allowing read-ahead operation to be performed until the number of read requests measured by the total-number-of-transfer-operations measurer 508 reaches the value specified by the total-number-of-transfer-operations holder 509, read-ahead operation can be performed for the entire DMA source area.

The values held by the number-of-successive-read-ahead-operations holder 510 and the total-number-of-transfer-operations holder 509 can be set and changed according to register settings of the master 301.

### Third Embodiment

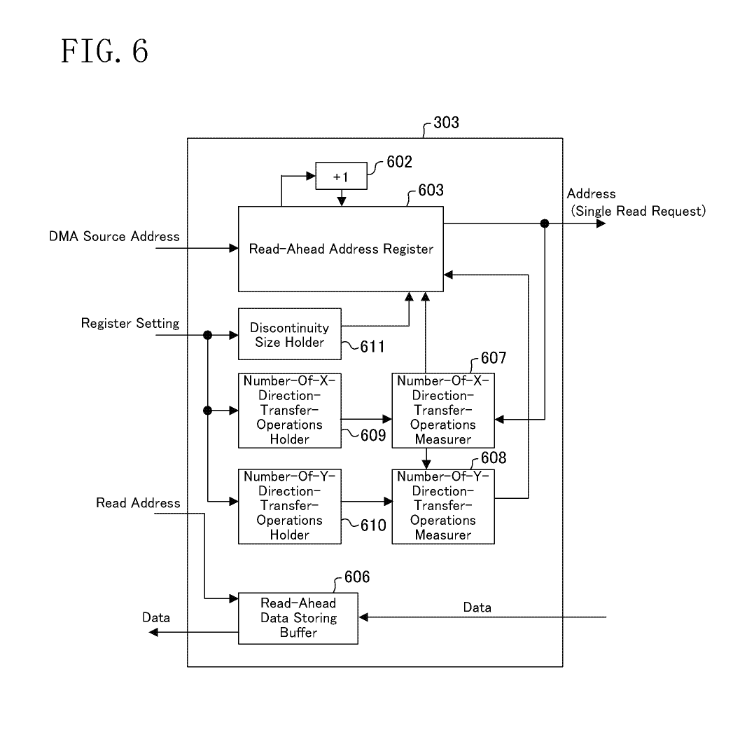

The DMA transfer device of this embodiment has an entire configuration shown in FIG. 3, and the read-ahead processor 303 of this embodiment has a configuration shown in FIG. 6.

As shown in FIG. 6, the read-ahead processor 303 includes an addition circuit 602, a read-ahead address register 603, a read-ahead data storing buffer 606, a number-of-X-direction-transfer-operations measurer 607, a number-of-Y-direction-transfer-operations measurer 608, a number-of-X-direction-transfer-operations holder 609, a number-of-Y-direction-transfer-operations holder 610, and a discontinuity size holder 611.

The read-ahead address register 603 issues a read request. The read-ahead data storing buffer 606 holds read data. The number-of-X-direction-transfer-operations measurer 607 counts the number of read requests. The number-of-X-direction-transfer-operations holder 609 holds the upper limit of the count of the number-of-X-direction-transfer-operations measurer 607. The discontinuity size holder 611 holds an offset value which is added to the read-ahead address register 603 if the count value of the number-of-X-direction-transfer-operations measurer 607 reaches the upper limit specified by the number-of-X-direction-transfer-operations holder 609. The number-of-Y-direction-transfer-operations measurer 608 holds the number of times that the offset is added. The number-of-Y-direction-transfer-operations holder 610 holds the upper limit of the count of the number-of-Y-direction-transfer-operations measurer 608.

Next, operation of the DMA transfer device 306 of this embodiment will be described.

When receiving a DMA source address from the source address setting detector 305, the read-ahead processor 303 stores the DMA source address into the read-ahead address register 603. Further, the read-ahead processor 303 issues a single read request to an address in the resource 304 which is held by the read-ahead address register 603 to read ahead one-word data, and stores the read-ahead one-word data into the read-ahead data storing buffer 606.

When receiving a read address from the DMAC 302, the read-ahead processor 303 returns to the DMAC 302 data which is already stored in the read-ahead data storing buffer 606, i.e., data in the resource 304 which is specified by the read address, and in addition, increments the address which is held by the read-ahead address register 603 by one word using the addition circuit 602, and reads ahead data in preparation for the next DMA transfer.

The number-of-X-direction-transfer-operations measurer 607 counts the number of read requests which are issued to the resource 304 by the read-ahead address register 603. When the count value of the number-of-X-direction-transfer-operations measurer 607 exceeds the value set in the number-of-X-direction-transfer-operations holder 609, the offset value held by the discontinuity size holder 611 is added to the address held by the read-ahead address register 603, and in addition, the number-of-Y-direction-transfer-operations measurer 608 increases the count by one, and the number-of-X-direction-transfer-operations measurer 607 resumes counting from zero. By performing a control so that read-ahead operation is repeated until the count value of the number-of-Y-direction-transfer-operations measurer 608 reaches the upper limit held by the number-of-Y-direction-transfer-operations holder 610, block-transfer read-ahead operation can be achieved.

Note that the values held by the number-of-X-direction-transfer-operations holder 609, the number-of-Y-direction-transfer-operations holder 610, and the discontinuity size holder 611 can be set and changed according to register settings of the master 301.

### Fourth Embodiment

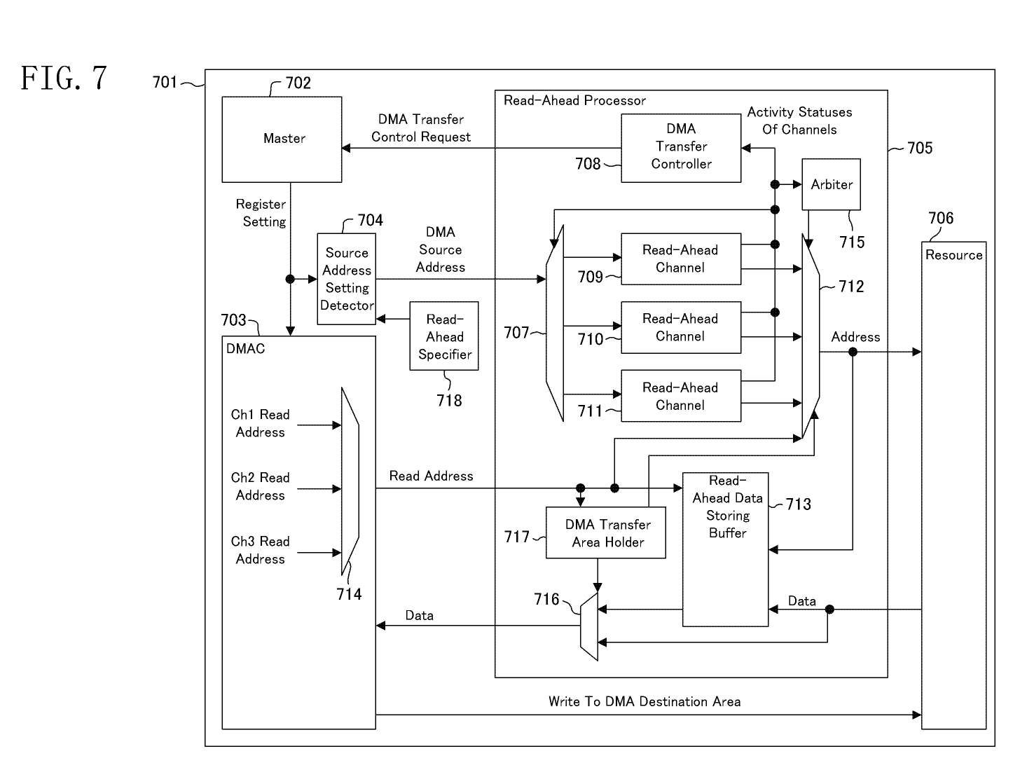

The DMA transfer device of this embodiment has an entire configuration shown in FIG. 7. The DMA transfer device 701 includes a DMAC 703 having a plurality of transfer channels, a master 702 which controls the DMAC 703, a source address setting detector 704, a read-ahead processor 705, a resource 706, and a read-ahead specifier 718.

The DMAC 703 includes an address selector 714 which arbitrates between read addresses output from the transfer channels to output one of the read addresses.

The read-ahead processor 705 includes an address selector 707, a DMA transfer controller 708, read-ahead channels 709-711, an address selector 712, a read-ahead data storing buffer 713, an arbiter 715, a data selector 716, and a DMA transfer area holder 717. The read-ahead channels 709-711 hold addresses. The address selector 712 selects one of the addresses stored in the read-ahead channels 709-711 and a read address received from the DMAC 703, and outputs the selected address to the resource 706. The read-ahead data storing buffer 713 includes a plurality of pairs of a data portion and a tag portion, and stores data read from the resource 706. The data selector 716 selects data stored in the read-ahead data storing buffer 713 or data output from the resource 706, and outputs the selected data to the DMAC 703. The DMA transfer area holder 717 holds an address range of a DMA source area from which data is read ahead by the read-ahead channels 709-711.

The source address setting detector 704 acquires a DMA source address from a transfer start address setting for the DMA source area of register settings which are made by the master 702 in order to allow one of the transfer channels of the DMAC 703 to start transfer. The address selector 707 investigates each of the read-ahead channels 709-711 as to whether or not the channel is being used, and stores the DMA source address into a free read-ahead channel. Further, when the master 702 performs register setting with respect to the DMAC 703 in order to allow another transfer channel of the DMAC 703 to start transfer, the source address setting detector 704 acquires a DMA source address again, and the address selector 707 investigates each of the read-ahead channels 709-711 as to whether or not the channel is being used, and stores the DMA source address into a free read-ahead channel.

The address selector 712 investigates each of the read-ahead channels 709-711 as to whether or not the channel is being used. When there is at least one read-ahead channel in which a DMA source address is stored, the address selector 712 selects one of the read-ahead channels in which the DMA source address is stored, and reads ahead data in the resource 706 which is specified by the address stored in the selected read-ahead channel, and stores the data into a data portion of the read-ahead data storing buffer 713. In this case, in order to be able to identify an address from which the data stored in the read-ahead data storing buffer 713 has been read, the address output to the resource 706 is stored into a tag portion corresponding to the data portion storing the data.

The DMAC 703, when register setting is completed for a transfer channel, starts DMA transfer in the transfer channel for which register setting is completed, and issues a read address to the read-ahead data storing buffer 713 in order to read data from the DMA source area. The read-ahead processor 705 investigates whether or not the read address received from the DMAC 703 falls within the DMA transfer range held by the DMA transfer area holder 717. When the read address falls within the DMA transfer range, data at the read address has already been read ahead into the read-ahead data storing buffer 713, and therefore, the read-ahead processor 705 compares the read address with the tag portions of the read-ahead data storing buffer 713, and returns data corresponding to a matching tag portion to the DMAC 703. On the other hand, when the read address does not fall within the DMA transfer range, the data at the read address has not been read ahead into the read-ahead data storing buffer 713, and therefore, the address selector 712 directly issues the read address to the resource 706, and the data selector 716 selects read data and directly returns the data to the DMAC 703.

As described above, the rate of DMA transfer performed by the DMAC 703 having a plurality of transfer channels can be increased by reading ahead data from the DMA source area in the resource (slave) 706.

Moreover, a control is performed so that, when a read address which does not fall within the address range of a DMA source area which is held by the DMA transfer area holder 717 is received from the DMAC 703, the read address received from the DMAC 703 is selected and output to the resource 706 by the address selector 712, and read data is selected and directly output to the DMAC 703 by the data selector 716. As a result, when all the read-ahead channels 709-711 are being used, DMA transfer in a transfer channel which is newly started by the master 702 can be controlled so that read-ahead operation is not started in the read-ahead channels 709-711.

The arbiter 715 performs arbitration so that the DMA source addresses stored in the read-ahead channels 709-711 are successively selected by the address selector 712 and a read request is sent to the selected address in the resource 706. As a result, data can be read ahead from a source area for a plurality of DMA transfer channels in a time-division manner.

The DMA transfer controller 708 monitors operating states of the read-ahead channels 709-711. If all the read-ahead channels 709-711 are being used, the DMA transfer controller 708 sends a DMA transfer control request to the master 702 so that no more channels of the DMAC 703 are newly activated. As a result, the master 702 can prevent activation of a larger number of transfer channels than what can be handled by the read-ahead processor 705.

The read-ahead specifier 718 puts a limitation on the read-ahead operation so that the source address setting detector 704 acquires only a DMA source address(s) of a specific channel(s) of the DMAC 703. As a result, a control can be performed so that the read-ahead operation is performed with respect to DMA transfer in only a transfer channel(s) of the DMAC 703 for which the read-ahead operation is required.

### Fifth Embodiment

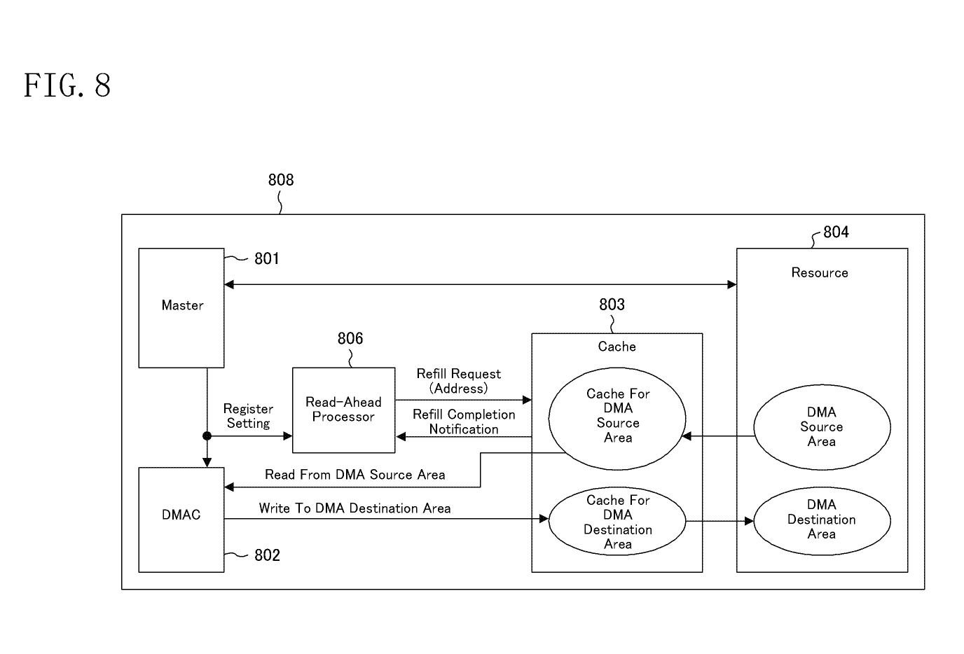

The DMA transfer device of this embodiment has an entire configuration shown in FIG. 8. The DMA transfer device 808 includes a DMAC 802, a master 801 which controls the DMAC 802, a cache 803, a resource 804, and a read-ahead processor 806. The cache 803 is used to store data in the resource 804 which is used by the DMAC 802. The DMAC 802 performs DMA transfer with respect to the resource 804 via the read-ahead processor 806 and the cache 803.

The read-ahead processor 806, when acquiring a DMA source address from a start address setting for a DMA source area of register settings for the DMAC 802 which are made by the master 801 in order to start DMA transfer, and a DMA transfer size from a DMA transfer size setting which specifies how many words are to be DMA-transferred, issues a refill request to the cache 803 so that data in the resource 804 which is specified by the DMA source address is stored into the cache 803. When receiving a refill completion notification which is output by the cache 803 after the refill operation is completed, the read-ahead processor 806 issues a refill request to the next address. A control is performed that, by repeating this, the entire DMA source area starting from the DMA source address and having the DMA transfer size is stored into the cache 803. Also, when the master 801 completes register settings for the DMAC 802, the DMAC 802 starts DMA transfer, i.e., reads out data of the DMA source area which is stored in the cache 803, and transfers the data to a DMA destination in the resource 804.

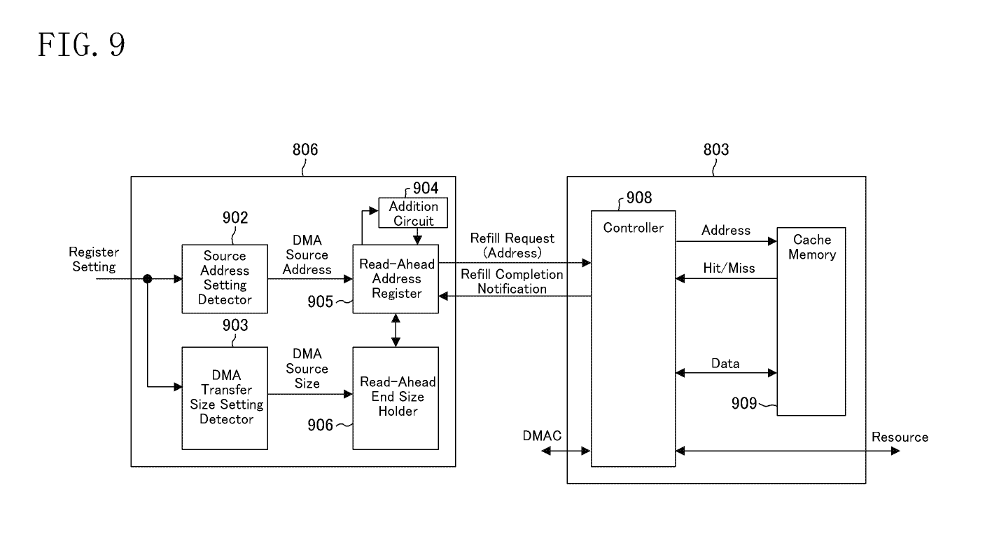

Next, configurations and operation of the read-ahead processor 806 and the cache 803 will be described. As shown in FIG. 9, the read-ahead processor 806 includes a source address setting detector 902, a DMA transfer size setting detector 903, an addition circuit 904, a read-ahead address register 905, and a read-ahead end size holder 906. The cache 803 includes a controller 908 and a cache memory 909.

The read-ahead processor 806 acquires from the source address setting detector 902 a DMA source address of the register settings which are made by the DMAC 802, and stores the DMA source address into the read-ahead address register 905. The read-ahead processor 806 also acquires a DMA transfer size from the DMA transfer size setting detector 903, and stores the DMA transfer size into the read-ahead end size holder 906. After completing both the storing operations, the read-ahead processor 806 issues a refill request to the address in the cache 803 which is held by the read-ahead address register 905.

When receiving the refill request from the read-ahead processor 806, the controller 908 in the cache 803 issues an address to the cache memory 909 in order to determine whether or not one word specified by the address contained in the refill request is present in the cache memory 909. In response to this, the cache memory 909 returns to the controller 908 a control signal which indicates “hit” if the data is present or “miss” if the data is not present. When receiving the control signal indicating “miss,” the controller 908 performs cache refilling operation, i.e., reads out one-word data in the resource 804 which is specified by the address contained in the refill request, and stores the data into the cache memory 909. When receiving the control signal indicating “hit” or when the cache refilling operation is ended, the controller 908 issues a refill completion notification to the read-ahead processor 806.

When receiving the refill completion notification, the read-ahead processor 806 increments the address stored in the read-ahead address register 905 by one word using the addition circuit 904, and issues a refill request again to the cache 803 so that the refill operation is performed with respect to the next DMA source area. By repeating this a number of times corresponding to words to be DMA-transferred which is specified by the DMA transfer size, the entire DMA source area in the resource 804 can be read ahead into the cache memory 909.

### Sixth Embodiment

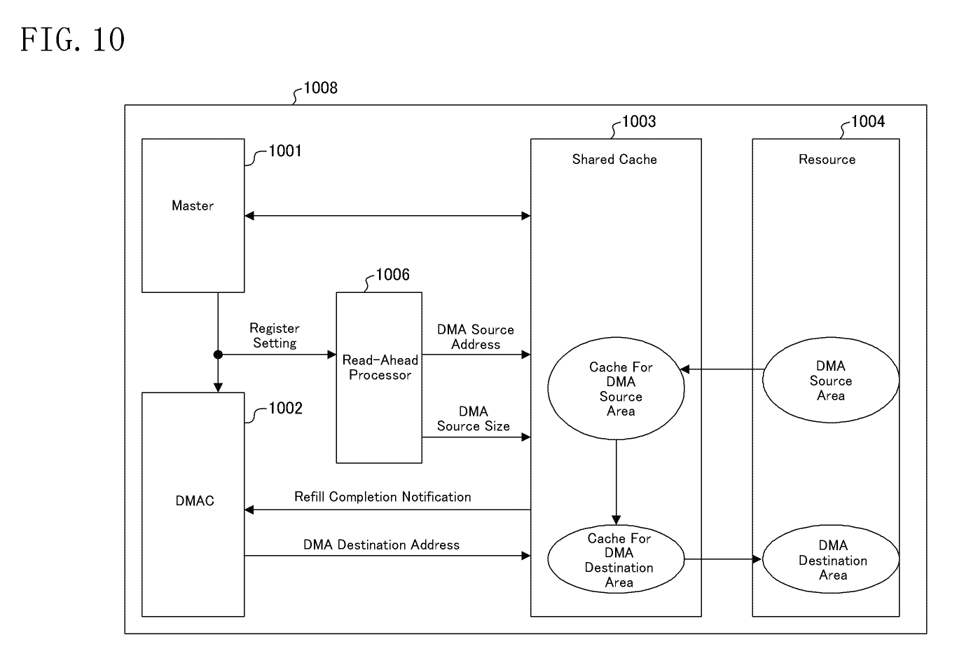

The DMA transfer device of this embodiment has an entire configuration shown in FIG. 10. The DMA transfer device 1008 includes a DMAC 1002, a master 1001 which controls the DMAC 1002, a shared cache 1003, a resource 1004, and a read-ahead processor 1006. The shared cache 1003 is used to store data in the resource 1004 which is used by the master 1001 and the DMAC 1002. The DMAC 1002 performs DMA transfer with respect to the resource 1004 via the read-ahead processor 1006 and the shared cache 1003.

The read-ahead processor 1006 monitors register settings for the DMAC 1002 which are made by the master 1001 in order to start DMA transfer, and acquires a DMA source address from a start address setting for a DMA source area of the register settings. The read-ahead processor 1006 also acquires a DMA transfer size from a DMA transfer size setting which specifies how many words are to be DMA-transferred, and issues the acquired DMA source address and DMA transfer size to the shared cache 1003.

The shared cache 1003 performs refill operation, i.e., reads from the resource 1004 a DMA source area starting from the received DMA source address and having the received DMA transfer size, and stores a copy of the data. Further, when the refill operation is completed for the entire DMA source area, the shared cache 1003 issues a refill completion notification to the DMAC 1002.

The refill completion notification allows the DMAC 1002 to recognize that the data of the DMA source area in the resource 1004 has been completely stored into the shared cache 1003. The DMAC 1002 issues a DMA destination address which is the leading address of the DMA source area, to the shared cache 1003, in order to output the stored DMA source data to the DMA destination. When receiving the DMA destination address, the shared cache 1003 transfers the DMA source area starting from the DMA source address and having the DMA transfer size in the shared cache 1003, which is specified by the read-ahead processor 1006, to a destination space in the shared cache 1003 starting from the DMA destination address and having the DMA transfer size.

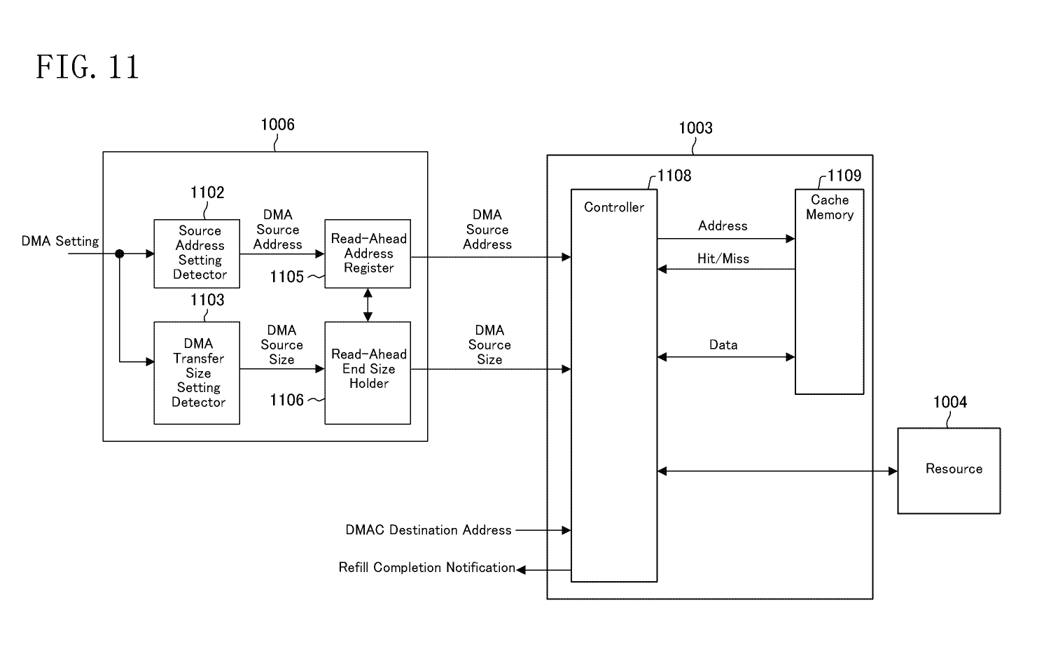

Next, detailed configurations and operation of the read-ahead processor 1006 and the shared cache 1003 will be described. As shown in FIG. 11, the read-ahead processor 1006 includes a source address setting detector 1102, a DMA transfer size setting detector 1103, a read-ahead address register 1105, and a read-ahead end size holder 1106. The shared cache 1003 includes a controller 1108 and a cache memory 1109.

The read-ahead processor 1006 acquires a DMA source address of the register settings which are made by the DMAC 1002, using the source address setting detector 1102, and stores the DMA source address into the read-ahead address register 1105. The read-ahead processor 1006 also acquires a DMA transfer size of the register settings which are made by the DMAC 1002, using the DMA transfer size setting detector 1103, and stores the DMA transfer size into the read-ahead end size holder 1106. After completing both the storing operations, the read-ahead address register 1105 and the read-ahead end size holder 1106 issue the DMA source address and the DMA transfer size, respectively, to the shared cache 1003.

When receiving the DMA source address and the DMA transfer size, the controller 1108 of the shared cache 1003 issues the received DMA source address to the cache memory 1109. The cache memory 1109 returns to the controller 1108 a control signal indicating “hit” if data is present at an address specified by the DMA source address or “miss” if data is not present at the address. When receiving the control signal indicating “miss,” the controller 1108 performs cache refilling operation, i.e., reads data in the resource 1004 which is specified by the DMA source address, and stores the data into the cache memory 1109. By repeating this with respect to an area starting from the DMA source address and having the DMA transfer size, the entire DMA source area can be stored into the cache. When the refill operation is completed, the controller 1108 issues a refill completion notification to the DMAC 1002 to notify the DMAC 1002 of completion of the refill operation.

When receiving the DMA destination address from the DMAC 1002, the controller 1108 of the shared cache 1003 reads data from a line (eight words) in the cache memory 1109 which is specified by the DMA source address, and writes the data to a line (eight words) in the cache memory 1109 which is specified by the DMA destination address. By repeating this, the entire DMA source area starting from the DMA source address and having the DMA transfer size is stored into the entire DMA destination area starting from the DMA destination address and having the DMA transfer size. As a result, data in the DMA source area which has been read ahead into the shared cache 1003 can be directly transferred to the DMA destination area in the shared cache 1003.

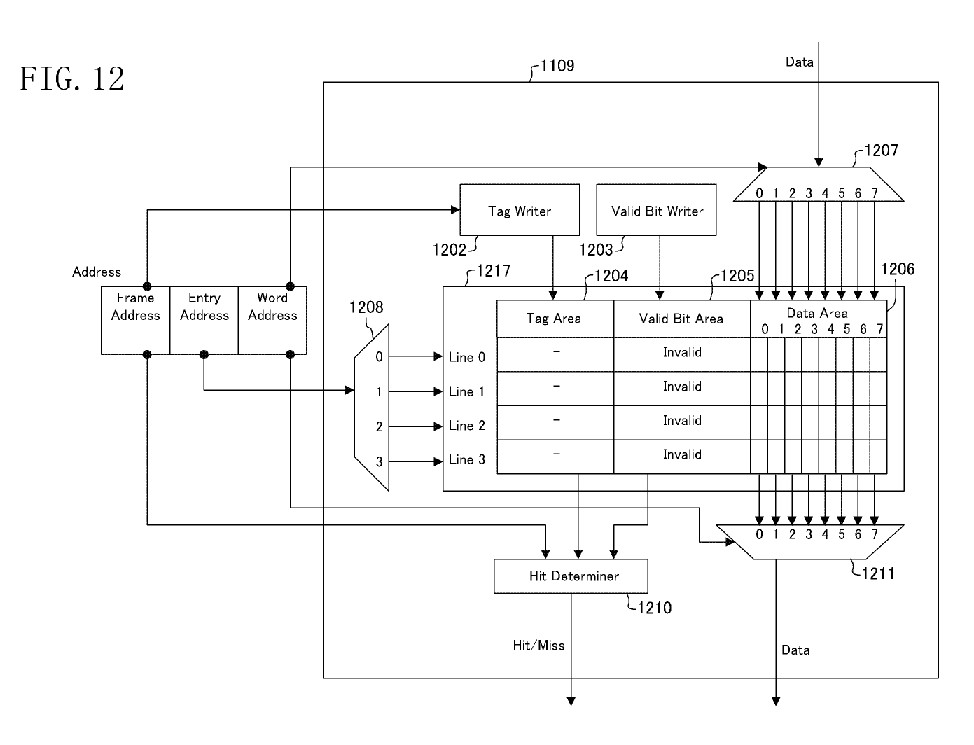

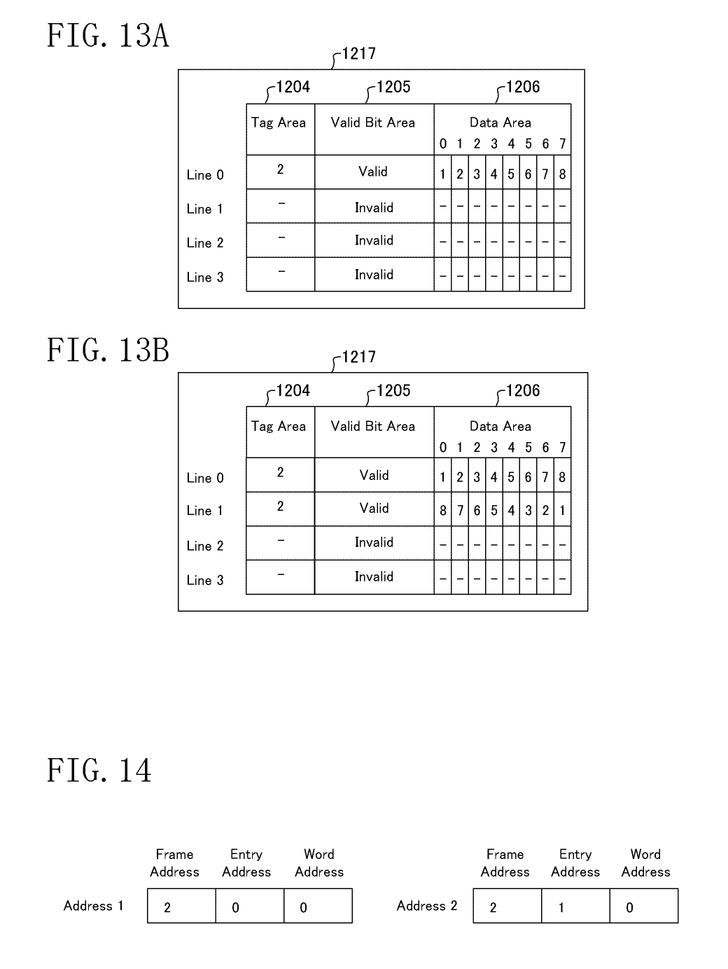

Next, operation and a configuration of the cache memory 1109 of FIG. 11 will be described (FIG. 12 shows a detailed configuration of the cache memory 1109), assuming that, when a memory unit 1217 is in an initial state shown in FIG. 13A, the cache memory 1109 receives a refill request that pieces of data in the resource 1004 which are specified by an address 1 and an address 2 of FIG. 14 be stored into the memory unit 1217.

Firstly, the configuration of the cache memory 1109 will be described. The cache memory 1109 is a set-associative cache. The memory unit 1217 includes a plurality of lines (lines 0-3), each of which includes a tag area 1204, a valid bit area 1205, and a data area 1206. The data area 1206 includes an eight-word area for storing a copy of data in the resource 1004. The tag area 1204 stores a part (frame address) of the address of the data stored in the data area 1206 for identification of the address. An address received by the cache memory 1109 includes the frame address, an entry address including an address range of 0-3 which is used to select one of the lines 0-3, and a word address including an address range of 0-7 for selecting a word from the data area 1206 containing eight words.

Next, the operation will be described. The controller 1108 outputs the address 1 (see FIG. 14) to the cache memory 1109 in order to determine whether or not data at the address 1 is already stored in the memory unit 1217. When receiving the address 1, an address decoder 1208 of the cache memory 1109 decodes the entry address 0 of the address 1 and selects the line 0 of the memory unit 1217 (see FIG. 13A). Next, a hit determiner 1210 determines whether or not the tag area 1204 of the line 0 (see FIG. 13A) matches the frame address of the address 1 (see FIG. 14), and the valid bit area 1205 of the line 0 is valid. Here, because all the conditions are satisfied, the hit determiner 1210 determines that the intended data is present in the line 0, and sends hit information to the controller 1108 to notify that the data is present in the cache memory 1109.

Next, when receiving the address 2 (see FIG. 14), the address decoder 1208 decodes the entry address 1 of the address 2 and selects the line 1 of the memory unit 1217. Next, the hit determiner 1210 determines whether or not the tag area 1204 of the line 1 matches the frame address 2 of the address 2, and the valid bit area 1205 in the line 1 is valid. Here, because the conditions are not satisfied, the hit determiner 1210 determines that data is not present in the line 1, and sends miss information to the controller 1108 to notify that data is not present in the cache memory 1109. When receiving the miss information, the controller 1108 reads out eight words in the address range of the word addresses 0-7 of the address 2 in the resource 1004, and controls a word decoder 1207 of the cache memory 1109 to successively write the eight words to word areas 0-7 of the data area 1206 in the line 1. Further, a tag writer 1202 stores the frame address 2 of the address 2 into the tag area 1204 of the line 1, and a valid bit writer 1203 sets the valid bit area 1205 of the line 1 to be valid. By the aforementioned operation, the cache memory 1109 can be refilled with DMA source data in the resource 1004, and therefore, the refilled memory unit 1217 is in a state shown in FIG. 13B.

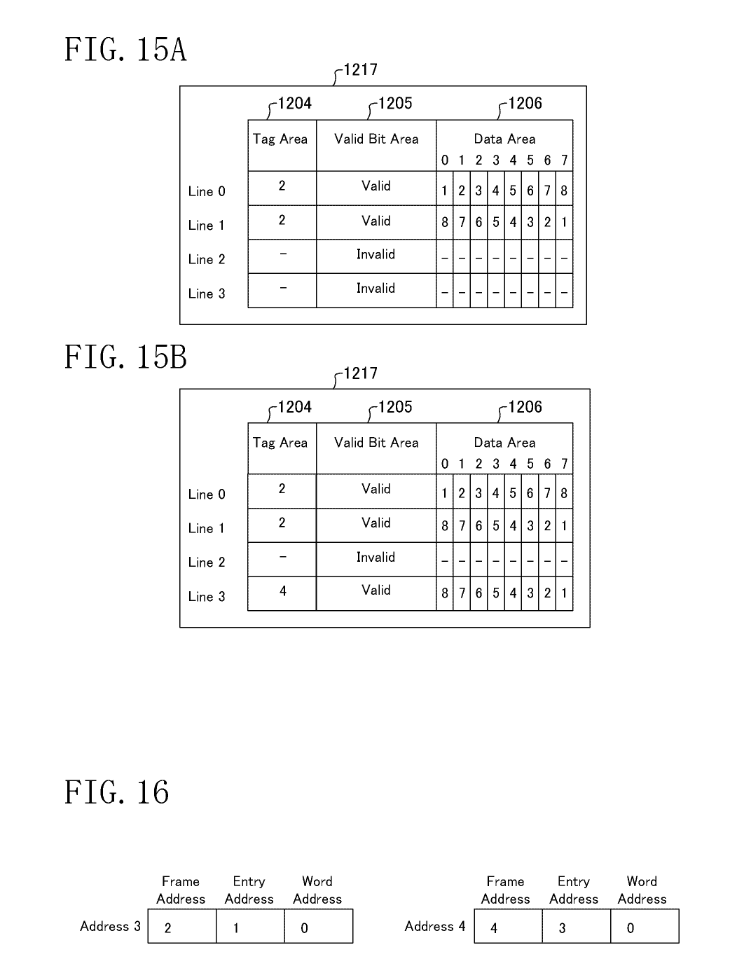

Next, cache operation of the cache memory 1109 of FIG. 11 will be described (FIG. 12 shows a detailed configuration of the cache memory 1109), assuming that, when the memory unit 1217 is in an initial state shown in FIG. 15A, the cache memory 1109 receives an address 3 and an address 4 shown in FIG. 16 from the controller 1108, reads data from a line (eight words) of a DMA source area in the memory unit 1217 which is specified by the address 3, and stores the data into a line (eight words) of a DMA destination area in the memory unit 1217 which is specified by the address 4.

When receiving the address 3 (see FIG. 16), the cache memory 1109 decodes the entry address 1 of the address 3 using the address decoder 1208, and selects the line 1 of the memory unit 1217. Next, the hit determiner 1210 determines whether or not the tag area 1204 of the line 1 matches the frame address 2 of the address 3, and the valid bit area 1205 of the line 1 is valid. Here, because all the conditions are satisfied, the hit determiner 1210 sends hit information to the controller 1108. A word selector 1211 successively reads out and sends the eight words in the data area 1206 of the line 1 to the controller 1108.

Next, the controller 1108 outputs the address 4 (see FIG. 16) and the eight words (DMA source data) which are previously read out, to the cache memory 1109 so that the data is written to a DMA destination. The cache memory 1109 decodes the entry address 3 of the address 4 using the address decoder 1208, and selects the line 3 of the memory unit 1217. Next, the cache memory 1109 stores the frame address 4 of the address 4 into the tag area 1204 of the line 3 using the tag writer 1202, sets the valid bit area 1205 of the line 3 to be valid using the valid bit writer 1203, and successively stores the received data into the word areas 0-7 of the data area 1206 of the line 3 using the word decoder 1207.

By the aforementioned operation, data in a line (eight words) of a DMA source area which is stored in the cache memory 1109 can be transferred to a DMA destination area in the cache memory 1109, and after the transfer, the memory unit 1217 is in a state shown in FIG. 15B.

Further, when data in a DMA source area which is stored in the cache memory 1109 is read out and stored into a DMA destination area in the cache memory 1109, then if the valid bit area 1205 of a line from which data has been read is invalidated by the valid bit writer 1203, and the transferred DMA source data is removed from the cache, the cache can be efficiently used.

### Seventh Embodiment

The DMA transfer device of this embodiment has the entire configuration of FIG. 10. The shared cache 1003 and the read-ahead processor 1006 of this embodiment have configurations shown in FIG. 11. The configuration and operation of each component are the same as those described in the sixth embodiment, except for the configuration of the cache memory 1109.

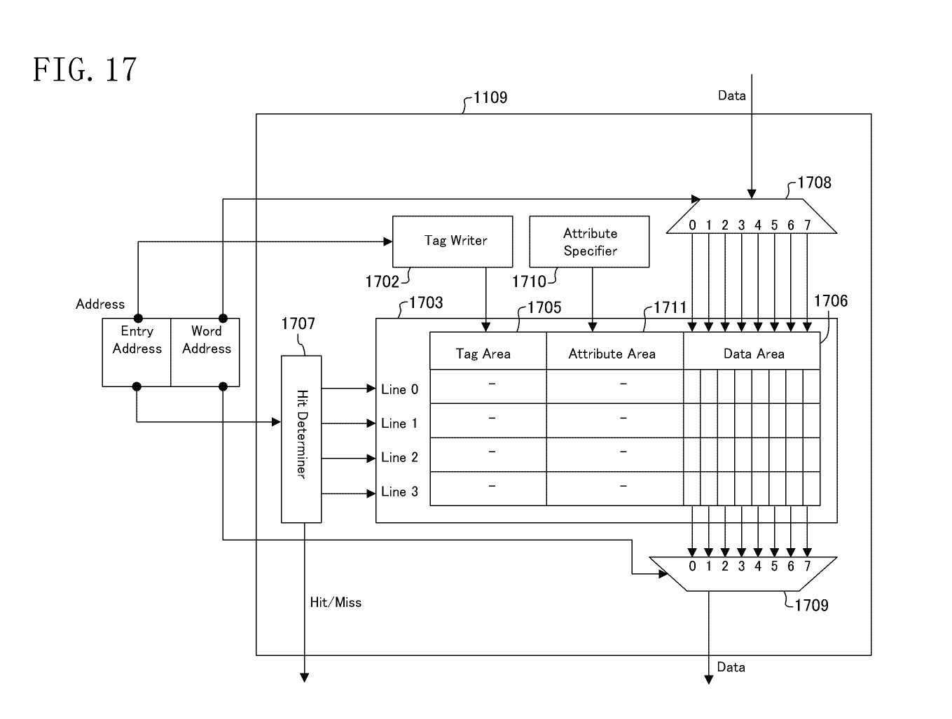

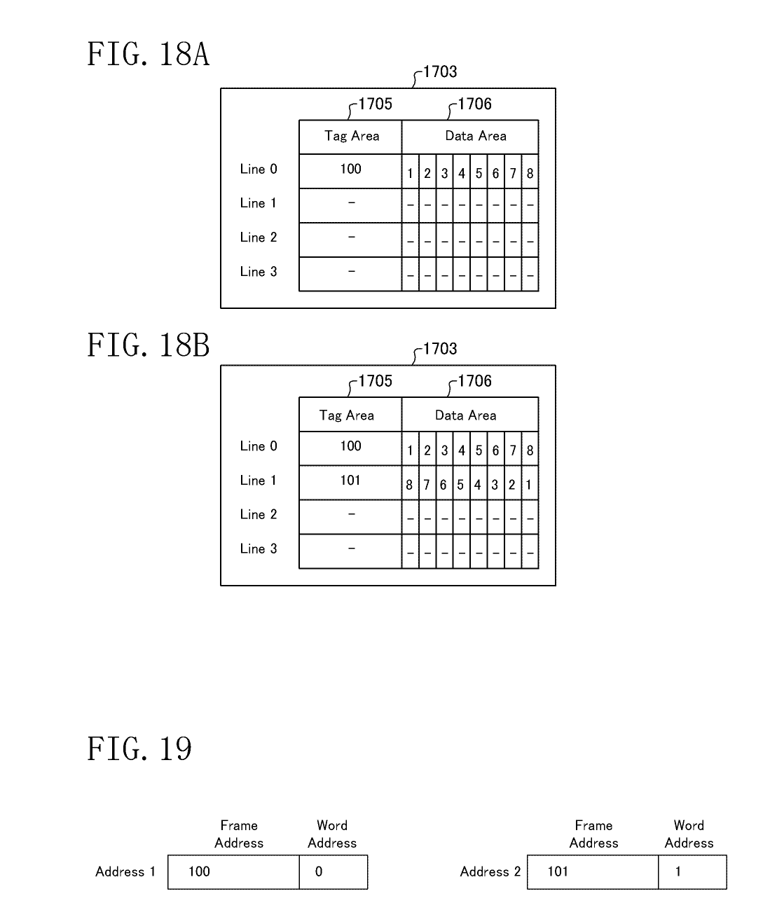

Operation and a configuration of the cache memory 1109 will be described (a detailed configuration of the cache memory 1109 is shown in FIG. 17), assuming that, when a memory unit 1703 is in an initial state shown in FIG. 18A, the cache memory 1109 receives a refill request that pieces of data in the resource 1004 which are specified by an address 1 and an address 2 shown in FIG. 19 be stored into the memory unit 1703.

Firstly, the configuration of the cache memory 1109 will be described. The cache memory 1109 is a full-associative cache. The memory unit 1703 includes a plurality of lines (lines 0-3), each of which includes a tag area 1705 and a data area 1706. The data area 1706 includes an eight-word area for storing a copy of data in the resource 1004. The tag area 1705 stores a part (frame address) of the address of the data stored in the data area 1706 for identification of the address. An address received by the cache memory 1109 includes the frame address and a word address. The word address includes an address range of 0-7 for selecting a word from the data area 1706 containing eight words.

Next, the operation will be described. The controller 1108 outputs the address 1 (see FIG. 19) to the cache memory 1109 in order to determine whether or not data at the address 1 is already stored in the memory unit 1703. When receiving the address 1, a hit determiner 1707 of the cache memory 1109 compares the frame address 100 of the address 1 with the tag areas 1705 of all lines in the memory unit 1703. Here, because there is a match for the line 0, the hit determiner 1707 determines that data is present in the line 0 of the cache memory 1109, and sends hit information to the controller 1108. Next, when receiving the address 2 (see FIG. 19), the hit determiner 1707 compares the frame address 101 of the address 2 with the tag areas 1705 of all lines in the memory unit 1703. Here, because there is no match, the hit determiner 1707 determines that data is not present in any line of the cache memory 1109, and sends miss information to the controller 1108. When receiving the miss information, the controller 1108 reads out eight words from the range of the word addresses 0-7 of the address 2 in the resource 1004, and successively writes the eight words to the range of the words 0-7 of the data area 1706 in the empty line 1 selected by the hit determiner 1707 by controlling the word decoder 1708. Further, the controller 1108 stores the frame address 101 of the address 2 into the tag area 1705 of the line 1 using the tag writer 1702. By the aforementioned operation, the cache memory 1109 can be refilled with DMA source data in the resource 1004, and the refilled memory unit 1703 is in a state shown in FIG. 18B.

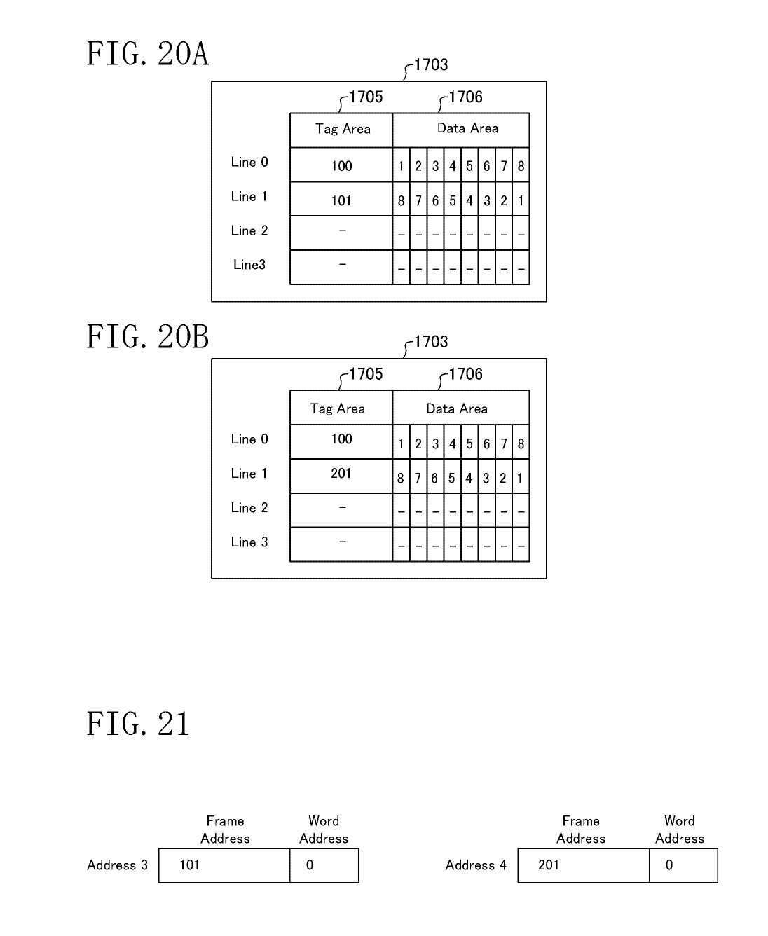

Next, cache operation of the cache memory 1109 of FIG. 11 will be described (FIG. 17 shows a detailed configuration of the cache memory 1109), assuming that, when the memory unit 1703 is in an initial state shown in FIG. 20, the cache memory 1109 receives an address 3 and an address 4 shown in FIG. 21 from the controller 1108, reads data from a line (eight words) of a DMA source area in the memory unit 1703 which is specified by the address 3, and stores the data into a line (eight words) of a DMA destination area in the memory unit 1703 which is specified by the address 4.

When receiving the address 3 (see FIG. 21), the cache memory 1109 compares the frame address 101 of the address 3 with the tag areas 1705 of all lines in the memory unit 1703 using the hit determiner 1707. Here, because there is a match for the line 1, the hit determiner 1707 selects the matching line 1, and further, sends hit information to the controller 1108 to notify the controller 1108 that there is data in the cache memory 1109. Next, when receiving the address 4, the cache memory 1109 rewrites the tag area 1705 of the line 1 previously selected by the hit determiner 1701 with the frame address 201 of the address 4 (see FIG. 21) using the tag writer 1702. As a result, data in a line (eight words) of the cache memory 1109 can be DMA-transferred. After the transfer, the memory unit 1703 is in a state shown in FIG. 20B.

Moreover, when a tag for a DMA source area is changed to one for a DMA destination area in the cache memory 1109, an attribute specifier 1710 specifies an attribute of the data as a write back attribute (WB) indicating that the data is held in the cache, a write through attribute (WT) indicating that the data is held in the cache and is also written to the resource 1004, or a non-bufferable attribute indicating that the data is not held in the cache. The cache attribute specified by the attribute specifier 1710 is held in an attribute area 1711 of the memory unit 1703. As a result, it is possible to specify whether data transferred to a DMA destination area in the cache memory 1109 is to be held in the cache memory 1109 or is to be written to the resource 1004.

### Eighth Embodiment

The DMA transfer device of this embodiment has the entire configuration of FIG. 10. The shared cache 1003 and the read-ahead processor 1006 of this embodiment have the configurations of FIG. 11. The configuration and operation of each component are the same as those described in the sixth embodiment, except for the configuration of the cache memory 1109.

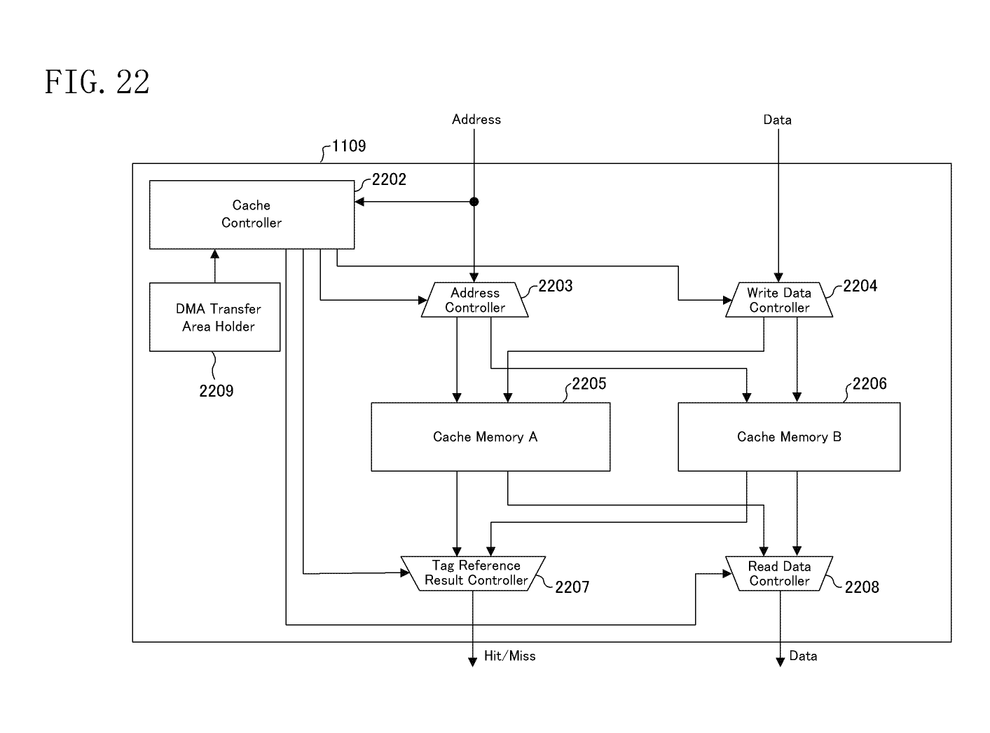

FIG. 22 shows a configuration of the cache memory 1109 of this embodiment. The cache memory 1109 includes a cache memory B 2206 which stores data to be DMA-transferred, and a cache memory A 2205 which stores other data.

When a read address and a write address are input to the cache memory 1109, a cache controller 2202 compares the read and write addresses with DMA transfer range addresses held in a DMA transfer area holder 2209. If the read and write addresses are within the range, the cache controller 2202 determines that DMA transfer is to be performed, and selects the cache memory B 2206. Otherwise, the cache controller 2202 selects the cache memory A 2205. An address controller 2203 performs a control so that the addresses are input to the cache memory 2205 or 2206 selected by the cache controller 2202. If there is data input to the cache memory 1109, a write data controller 2204 performs a control so that the data is input to the cache memory 2205 or 2206 selected by the cache controller 2202. A tag reference result controller 2207 selects hit or miss information output from the cache memory 2205 or 2206 selected by the cache controller 2202, and outputs the selected information to the controller 1108. If there is data output from the cache memory 2205 or 2206 selected by the cache controller 2202, a read data controller 2208 selects and outputs the data to the controller 1108. By the aforementioned operation, a cache memory which is used in DMA transfer by the DMAC 1002 and a cache memory which is used by the master 1001 can be separated from each other.

### Ninth Embodiment

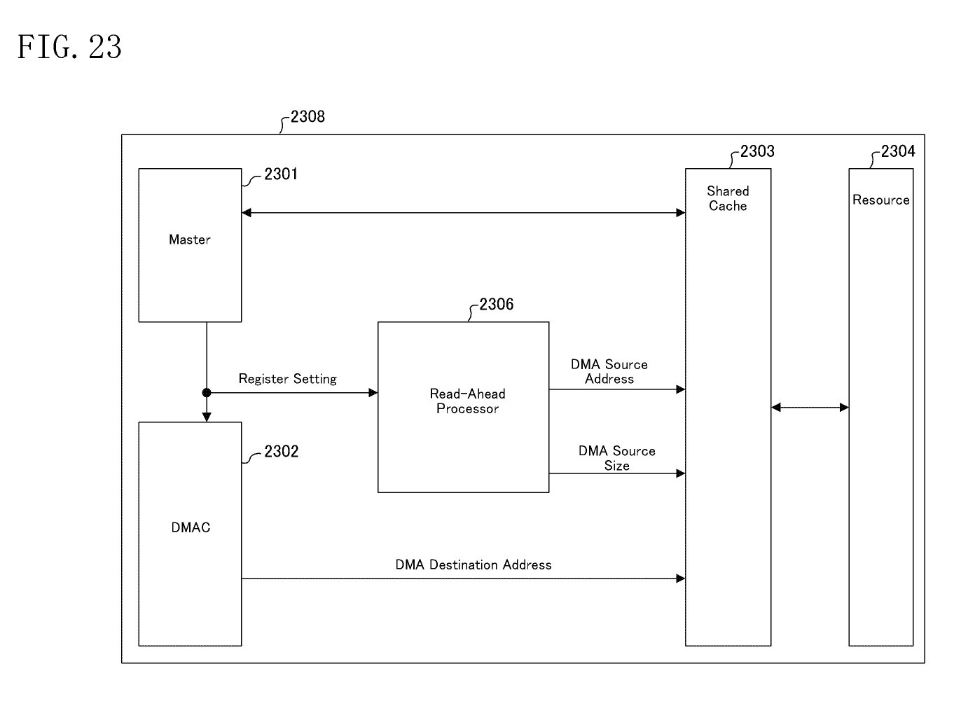

The DMA transfer device of this embodiment has an entire configuration shown in FIG. 23. The DMA transfer device 2308 includes a DMAC 2302, a master 2301 which controls the DMAC 2302, a shared cache 2303, a resource 2304, and a read-ahead processor 2306. The shared cache 2303, which is shared by the master 2301 and the DMAC 2302, stores data in the resource 2304. The DMAC 2302 performs DMA transfer with respect to the resource 2304 via the read-ahead processor 2306 and the shared cache 2303.

Next, operation of each component will be described. The shared cache 2303 reads ahead data in the resource 2304 which is specified by a DMA source address received from the read-ahead processor 2306. The DMAC 2302 starts DMA transfer after the master 2301 completes register settings, and issues to the shared cache 2303 a DMA destination address which is the leading address of a DMA destination area in the resource 2304. The shared cache 2303, when receiving the DMA destination address, stores the read-ahead data into an area in the shared cache 2303 which is specified by the DMA destination address.

Further, the shared cache 2303 increments the DMA source address and the DMA destination address, stores data in the resource 2304 which is specified by the DMA source address into a DMA destination address area in the shared cache 2303. By repeating this until the stored data reaches a DMA transfer size, all data in the DMA source area of the resource 2304 can be stored into the DMA destination area of the shared cache 2303.

The read-ahead processor 2306 performs operation similar to that of the read-ahead processor 1006 (FIG. 10) described in the sixth embodiment.

The present invention is useful for semiconductor devices in which DMA transfer is quickly started or is performed at a high rate.

1. A DMA transfer device comprising:
a direct memory access controller (DMAC);
a master configured to control the DMAC;
at least one resource configured to be accessed in direct memory access (DMA) transfer;
a source address setting detector configured to acquire a DMA source address from a transfer start address setting for a DMA source area of register settings for the DMAC which are made by the master in order to start DMA transfer; and
a read-ahead processor configured to issue a read request to the DMA source address in the resource detected by the source address setting detector.

2. A DMA transfer device comprising:
a direct memory access controller (DMAC) including a plurality of transfer channels;
a master configured to control the direct memory access controller (DMAC);
at least one resource configured to be accessed in DMA transfer;
a source address setting detector configured to acquire a DMA source address for each of the transfer channels, from a transfer start address setting for a DMA source area of register settings which are made by the master for the each of the transfer channels of the DMAC in order to start the corresponding DMA transfer; and
a read-ahead processor,
wherein
the read-ahead processor includes one or more read-ahead channels configured to hold the DMA source addresses detected by the source address setting detector,
the read-ahead processor issues a read request to the DMA source address in the resource held by each of the read-ahead channels.

3. The DMA transfer device of claim 2, further comprising:
a DMA transfer controller configured to request the master not to start any more DMA transfer when all of the read-ahead channels are being used.

4. The DMA transfer device of claim 2, wherein
when all of the read-ahead channels are being used, a DMA source address is not stored into any of the read-ahead channels in DMA transfer in one of the transfer channels which is newly started by the master.

5. The DMA transfer device of claim 2, wherein
a DMA source address is not stored into any of the read-ahead channels in DMA transfer other than those of one or more specific ones of the transfer channels.

6. The DMA transfer device of claim 2, further comprising:
an arbiter configured to arbitrate between read requests output from the plurality of read-ahead channels.

7. The DMA transfer device of claim 1, further comprising:
a read-ahead data storing buffer configured to store data read ahead according to the read request output from the read-ahead processor.

8. The DMA transfer device claim 1, further comprising:
a cache configured to store data read ahead according to the read request output from the read-ahead processor.

9. The DMA transfer device of claim 1, further comprising:
a shared cache configured to store data read ahead according to the read request output from the read-ahead processor, the shared cache being shared by the DMAC and one or more bus masters.

10. The DMA transfer device of claim 9, wherein
the shared cache includes a plurality of caches,
at least one of the plurality of caches is exclusively used by the DMAC, and
the data read ahead according to the read request output from the read-ahead processor is stored into the cache exclusively used by the DMAC.

11. The DMA transfer device of claim 8, wherein
the read-ahead data is stored into a DMA source address area in the cache or the shared cache, and is written to a DMA destination by storing a copy of the data into a DMA destination address area in the cache or the shared cache.

12. The DMA transfer device of claim 11, wherein
the DMA source address area in the cache or the shared cache into which the copy of the data has been stored is invalidated.

13. The DMA transfer device claim 8, wherein
the read-ahead data is stored into a DMA source address area in the cache or the shared cache, and is written to a DMA destination by changing a tag of the DMA source address area in the cache or the shared cache to a tag of a DMA destination address area.

14. The DMA transfer device of claim 8, wherein
the read-ahead data is stored into a DMA destination address area in the cache or the shared cache.

15. The DMA transfer device of claim 11, further comprising:
an attribute specifier configured to write a cache attribute to a tag area of the cache when the read-ahead data is written to a destination address area in the cache or the shared cache.

16. The DMA transfer device of claim 1, wherein
after issuing the read request, the read-ahead processor increments the DMA source address and issues another read request.

17. The DMA transfer device of claim 16, further comprising:
a read-ahead end address holder,
wherein
when the DMA source address reaches an address held by the read-ahead end address holder, the incrementation is stopped and read-ahead operation is ended.

18. The DMA transfer device of claim 16, further comprising:
a total-number-of-transfer-operations measurer configured to measure the number of times that the read-ahead processor issues a read request; and
a total-number-of-transfer-operations holder configured to hold an upper limit of the total number of transfer operations which can be measured by the total-number-of-transfer-operations measurer,
wherein
when a value measured by the total-number-of-transfer-operations measurer reaches the upper limit held by the total-number-of-transfer-operations holder, read-ahead operation is ended.

19. The DMA transfer device of claim 16, further comprising:
a number-of-successive-read-ahead-operations measurer configured to measure the number of times that the read-ahead processor issues a read request before the DMAC issues a read request; and
a number-of-successive-read-ahead-operations holder configured to hold an upper limit of the number of successive read ahead operations which can be measured by the number-of-successive-read-ahead-operations measurer,
wherein
when a value measured by the number-of-successive-read-ahead-operations measurer reaches the upper limit held by the number-of-successive-read-ahead-operations holder, read-ahead operation is stopped.

20. The DMA transfer device of claim 1, wherein
read-ahead operation is performed by single transfer.

21. The DMA transfer device of claim 1, wherein
read-ahead operation is performed by burst transfer.

22. The DMA transfer device of claim 1, wherein
when block transfer is performed, read-ahead operation is performed.

23. The DMA transfer device of claim 1, wherein
activation and inactivation of the read-ahead processor can be controlled.

24. The DMA transfer device of claim 1, further comprising:
a DMA transfer size detector configured to acquire a DMA transfer size from a DMA transfer size setting indicating how many words are to be DMA-transferred of the register settings for the DMAC which are made by the master in order to start DMA transfer.
